(19) United States
(12) Patent Application Publication
(10) Pub. No.: US 2010/0235564 A1
(43) Pub. Date: Sep. 16, 2010

(54) SEMICONDUCTOR MEMORY DEVICE

(76) Inventor: Takafumi ITO, Ome-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/558,706

(22) Filed: Sep. 14, 2009

(30) Foreign Application Priority Data
Mar. 11, 2009 (JP) 2009-058359

(51) Int. Cl. G06F 12/00; G06F 12/02

(52) U.S. Cl. 711/103; 711/E12.001; 711/E12.008

(57) ABSTRACT

First conversion from a logical address to a physical address is performed, and data is written in to a region in a first storage region specified by the first conversion. Second conversion from a logical address to a physical address which is different from the first conversion is performed, and data is written into a region in a second storage region specified by the second conversion. When the controller detects sequential writing having a predetermined length or more, it shifts to a first write mode that data is written into the first storage region. When the controller detects that a difference between a logical address at the end of a previous write operation and a logical address at the start of a subsequent write operation is not present in a predetermined range, it shifts to a second write mode that data is written into the second storage region.

### CROSS-REFERENCE TO RELATED APPLICATIONS

This application is based upon and claims the benefit of priority from prior Japanese Patent Application No. 2009-058359, filed Mar. 11, 2009, the entire contents of which are incorporated herein by reference.

### BACKGROUND OF THE INVENTION

1. Field of the Invention

The present invention relates to a semiconductor memory device and to, e.g., a flash memory device.

2. Description of the Related Art

A hard disk drive (HDD) has been used as one of examples for a swap data storing destination in a virtual storage region of a main memory (e.g., a DRAM) of a personal computer (which will be referred to as a PC hereinafter), but in recent years there is a trend to use a flash memory medium such as a USB flash memory for a swap data storing destination to improve the performance at the time of swapping. A “Readyboost (a registered trademark)” function installed in Windows (a registered trademark) Vista (a registered trademark) by Microsoft (a registered trademark) is a typical example of this trend.

To effectively use this technology, i.e., the “Readyboost” function that improves the performance, a USB flash memory requires the high-speed random write performance. The following performance specification is required for the USB flash memory that can be used for the “Readyboost”. “Random write” stated below means to write data at a random logical address.

(1) Available specification . . . the random write performance per 512 KB is 2 MB/sec or more.

(2) Recommended specification . . . the random write performance per 512 KB is 3 MB/sec or more.

On the other hand, in an NAND flash memory used in the USB flash memory, a physical block size (1 MB or more) has been increasing in realization of a large memory capacity. In the NAND flash memory, data can be erased in unit of a physical block and data can be sequentially written (sequential writing in ascending order of page addresses) in unit of a page of the block (e.g., 16 KB). Therefore, data move (copy for move) occurs with respect to the random write in a regular data write scheme.

In the USB flash memory, an influence of overhead for the write performance involved in the data move increases as the physical block size becomes larger, obtaining the random write performance required by the Readyboost may possibly become difficult.

### BRIEF SUMMARY OF THE INVENTION

According to a first aspect of the present invention, there is provided a semiconductor memory device which includes a plurality of blocks each having a plurality of memory cells and in which data is erased in a unit of the block, the device comprising: a first storage region which has a plurality of blocks and in which first conversion from a logical address to a physical address is performed and data is written into a region specified by the physical address converted based on the first conversion; a second storage region which has a plurality of blocks and in which second conversion from a logical address to a physical address, the second conversion being different from the first conversion, is performed and data is written into a region specified by the physical address converted based on the second conversion; and a controller which controls writing data into the first storage region and the second storage region, wherein the controller shifts to a first write mode that data is written into the first storage region when the controller detects sequential writing of data having a predetermined length or more, and the controller shifts to a second write mode that data is written into the second storage region when the controller detects that a difference between a logical address at the end of a previous write operation and a logical address at the start of a subsequent write operation is not present in a predetermined range.

According to a second aspect of the present invention, there is provided a semiconductor memory device which includes a plurality of blocks each having a plurality of memory cells and in which data is erased in a unit of the block, the device comprising: a first storage region which has a plurality of blocks and in which first conversion from a logical address to a physical address is performed and data is written into a region specified by the physical address converted based on the first conversion; a second storage region which has a plurality of blocks and in which second conversion from a logical address to a physical address, the second conversion being different from the first conversion, is performed and data is written into a region specified by the physical address converted based on the second conversion; and a controller which controls writing data into the first storage region and the second storage region, wherein the controller shifts to one of a first write mode that data is written into the first storage region and a second write mode that data is written into the second storage region depending on whether writing data at random addresses in units of a predetermined storage capacity is detected.

### BRIEF DESCRIPTION OF THE SEVERAL VIEWS OF THE DRAWING

FIG. 1 is a block diagram showing a configuration of a USB flash memory according to each of first and second embodiments of the present invention;

FIGS. 2 and 3 are flowcharts showing a write operation in the USB flash memory according to each of the first and second embodiments;

FIG. 4 is a flowchart showing a write operation in the USB flash memory according to the first embodiment;

FIG. 5 is a view showing writing data into a write-once buffer region in the write operation according to each of the first and second embodiments;

FIG. 6 is a view showing writing data into a regular data region in the write operation according to each of the first and second embodiments;

FIG. 7 is a view showing data movement from the write-once buffer region to the regular data region in the write operation according to each of the first and second embodiments; and

FIG. 8 is a flowchart showing a write operation in the USB flash memory according to the second embodiment.

### DETAILED DESCRIPTION OF THE INVENTION

Embodiments according to the present invention will now be described hereinafter with reference to the accompanying drawings. Here, a USB flash memory will be taken as an example of a semiconductor memory device. In a description, like reference numerals denote like parts throughout the drawings.

### First Embodiment

A USB flash memory according to a first embodiment of the present invention will be first described.

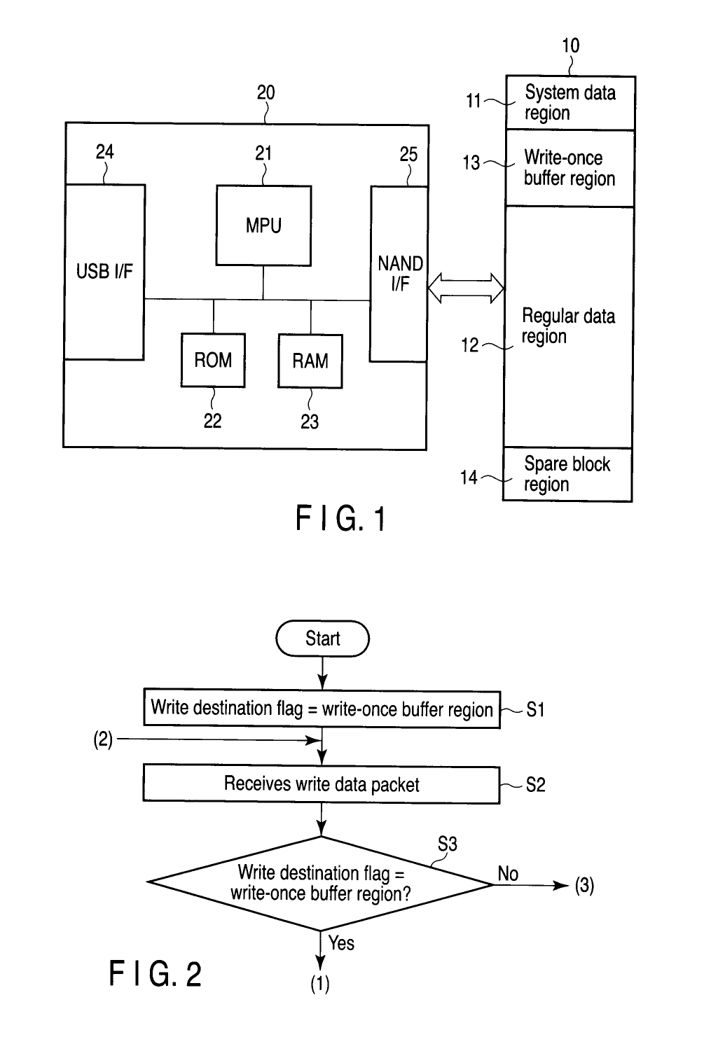

FIG. 1 is a block diagram showing a configuration of the USB flash memory according to the first embodiment. The USB flash memory has an NAND flash memory 10 and a controller 20 that controls operations of this NAND flash memory. The NAND flash memory 10 includes a plurality of blocks (logical blocks) each having a plurality of memory cells, and data is erased in a unit of the block. A block size (a storage capacity of the block) is, e.g., 1 MB or 1.5 MB.

The respective blocks of the NAND flash memory 10 are classified into a system data region 11 which stores a logical/physical conversion table or controller control information, a regular data region 12 which stores regular data, and a write-once buffer region 13 which is used to perform the random write at a high speed. Besides, there is also a spare block region 14 which is used for data move or replacement of a defective block. The logical/physical conversion table is a table which is used to convert a logical address into a physical address. Each of the system data region 11, the regular data region 12, the write-once buffer region 13, and the spare block region 14 includes a plurality of blocks each having a plurality of nonvolatile memory cells.

For example, in case of a USB flash memory having a storage capacity of 4 GB, the regular data region 12 of 4 GB, the write-once buffer region 13 of 128 MB, and the system data region 11 of approximately 32 MB are prepared.

The controller 20 includes an MPU 21, an ROM 22, an RAM 23, a USB interface (a USB I/F) 24, and an NAND interface (an NAND I/F) 25. The USB interface 24 performs interface processing between an external host device, e.g., a PC (which will be referred to as a host PC) and the controller 20. The MPU 21 controls operations in the USB flash memory. In more detail, the MPU 21 receives a write command, a read command, and an erase command from the host PC, and executes predetermined processing with respect to the NAND flash memory 10 or executes data movement processing to move data from the write-once buffer region 13 to the regular data region 12.

The ROM 22 stores firmware (a control program) for the MPU, fixed data, and others. The RAM 23 stores various conversion tables or variables, and it is used as a work area for the MPU 21. The NAND interface 25 carries out interface processing between the controller 20 and the NAND flash memory 10.

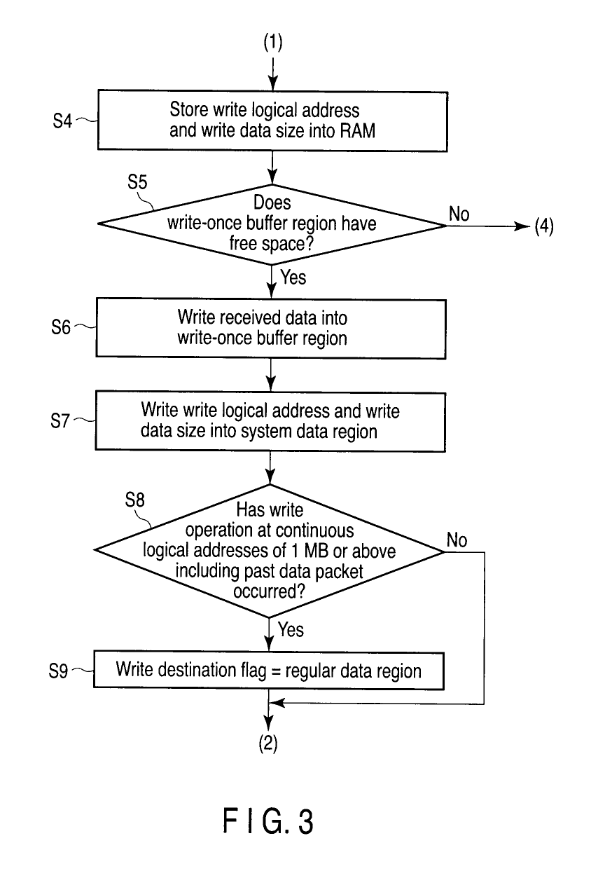

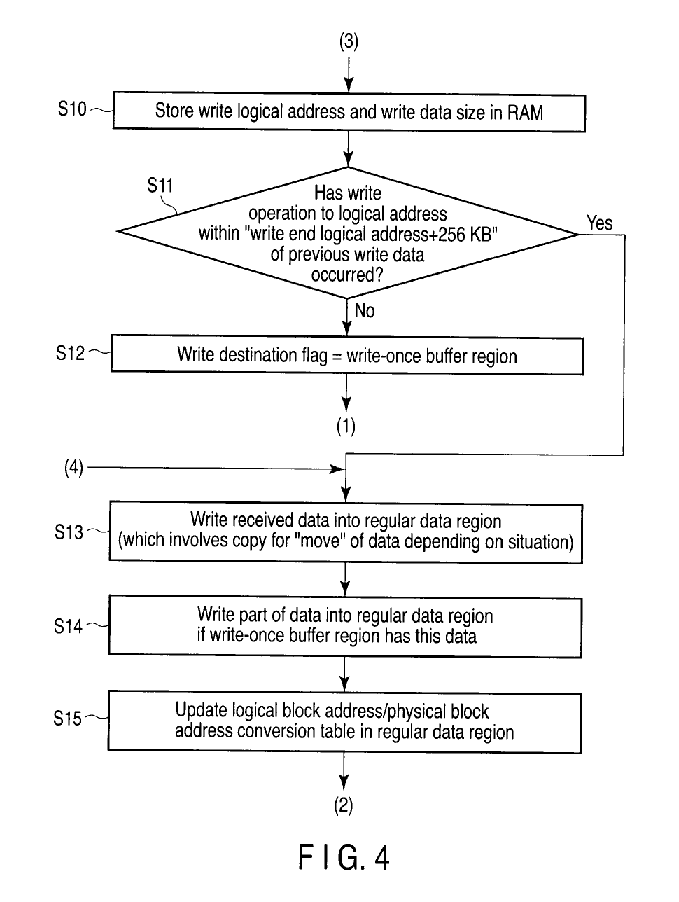

A data write operation in the USB flash memory according to the first embodiment will now be described. FIGS. 2 to 4 are flowcharts showing the data write operation in the USB flash memory according to the first embodiment.

When the write operation starts, first, a “write destination flag” of the RAM 23 is set to the write-once buffer region 13, namely, an operation at the time of writing is set to a “write-once buffer write mode” (a step S1). Subsequently, the MPU 21 receivers write data through packet communication (a step S2). Then, the MPU 21 judges whether the “write destination flag” set in the RAM 23 has been set to the write-once buffer region 13 (a step S3).

That is, the RAM 23 in the controller 20 has the “write destination flag”, and the MPU 21 identifies which one of the “write-once buffer write mode” or a “regular write mode” is used by judging a state of the “write destination flag”. The “write-once buffer write mod” is a mode that writes data received from the host PC is written into the write-once buffer region 13, and the “regular write mode” is a mode that the write data is written into the regular data region 12. In an initial state after turning on a power supply, the “write destination flag” has been set to the “write-once buffer write mode”.

Then, when the “write destination flag” has been set to the write-once buffer region 13, the control advances to (1) to execute processing in the “write-once buffer write mode” at a step S4 and subsequent steps.

At the step S4, a write logical address and a write data size of the write data are stored in the RAM 23. Subsequently, whether the write-once buffer region 13 has a free space is judged (a step S5). When the write-once buffer region 13 has a free space, the received write data is written into the write-once buffer region 13 (a step S6). Furthermore, the write logical address and the write data size of the write data are stored in the system data region 11 (a step S7).

That is, when the “write-once buffer write mode” is adopted (to (1)) at the step S3 in FIG. 2 and when the write-once buffer region 13 has a free space for data writing (when YES at the step S5 in FIG. 3), the MPU 21 writes the write data received from the host PC into the write-once buffer region 13 (the steps S4 to S6). Moreover, the write logical address and the write data size (a data length) of the write data are stored in the system data region 11 (the step S7).

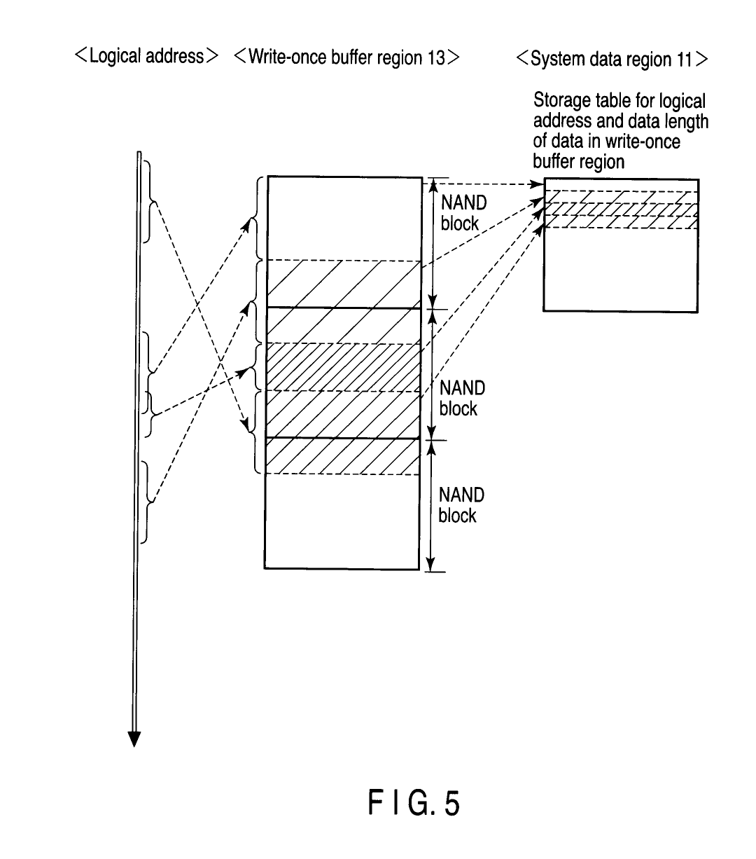

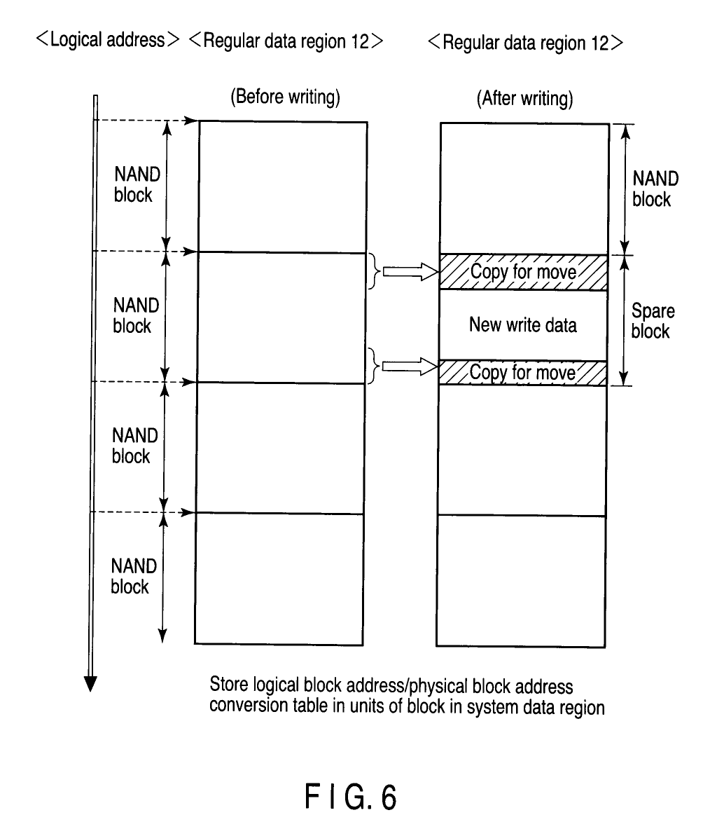

As explained above, the “write-once buffer write mode” means processing of writing the received write data into the write-once buffer region 13 as it is and storing the write logical address and the write data size thereof in the system data region 11 as a stored table as shown in FIG. 5. In the “write-once buffer write mode”, as shown in FIG. 6, since move processing like a regular write operation does not occur, the random write can be performed at a high speed.

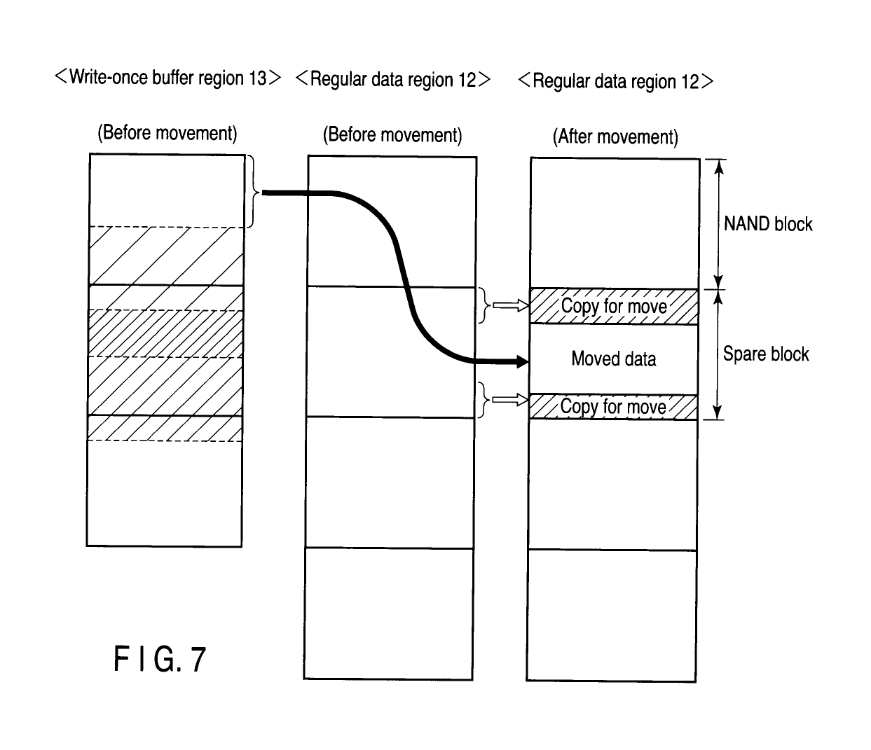

It is to be noted that the logical address overlaps between data which has been stored in the regular data region 12 and data which has been written in the “write-once buffer write mode”. Thus, a write logical address and a write data size subjected to the write operation in the “write-once buffer write mode” need be written into the system data region 11. Additionally, since overflow eventually occurs in the write-once buffer region 13 as a result of repetition of the write operation in the “write-once buffer write mode”, processing of moving data stored in the write-once buffer region 13 to the regular data region 12 at a predetermined timing is required as shown in FIG. 7, thereby assuring a free space in the write-once buffer region 13. The predetermined timing may be provided immediately after the write operation in the regular data region 12 as will be described in relation to a step S14, or it may be provided simultaneously with the write operation in the regular data region 12. Further, it may be provided in initialization, or it may be provided during a period that no access is made to the controller from the outside.

Then, the MPU 21 judges whether a write operation including past data packet communication has been executed at continuous logical addresses of 1 MB or more (a step S8). When the write operation has not been executed at the continuous logical addresses of 1 MB or more, the control advances to (2) and returns to the step S2 to perform the processing at the step S2 and the subsequent steps.

On the other hand, when the write operation has been executed at the continuous logical addresses of 1 MB or more, the “write destination flag” is set to the regular data region 12. That is, an operation at the time of writing is set to the “regular write mode” (a step S9). Subsequently, the control advances to (2) and returns to the step S2 to execute the processing at the step S2 and the subsequent steps.

That is, when the MPU 21 detects sequential writing having a predetermined length (1 MB in the example depicted in FIG. 3) in the “write-once buffer write mode”, the MPU 21 then sets the “write destination flag” to the “regular write mode” (steps S8 and S9).

Then, when the “write destination flag” has not been set to the “write-once buffer region 13, i.e., when the “write destination flag” is set to the regular data region 12 in the judgment on whether the “write destination flag” has been set to the write-once buffer region 13 at the step S3, the control advances to (3) and shifts to a step S10 to perform the processing in the “regular write mode” at the step S10 and subsequent steps.

At the step S10, a write logical address and a write data size of the write data are stored in the RAM 23. Subsequently, whether the current write operation is a write operation to a logical address within a “(logical address at the end of the write operation)+256 KB” is judged (a step S11). When the current write operation is a write operation to a logical address within a “(logical address at the end of the write operation)+256 KB”, the control shifts to a step S13. At the step S13, data received from the host PC is written into the regular data region 12 (at this time, “copy for move” of the data is involved depending on a situation).

That is, in the “regular write mode”, the write data received from the host PC is directly written into the regular data region 12. Although the overhead involved by the “copy for move” occurs depending on a write logical address. However, if the sequential writing continues in subsequent operations or if discontinuity of addresses is small even though the complete sequential writing is not performed (a step S11), a small amount of data to be moved can suffice. Therefore, the overhead involved by the “copy for move” can be reduced, and a data writing speed is not decreased.

Then, when the write-once buffer region 13 has data stored therein, a part of the data is written into the regular data region 12 (a step S14). In the “regular write mode”, the write data is written into the regular data region 12 and processing of increasing a free space in the write-once buffer region 13 is executed by moving data in the write-once buffer region 13 to the regular data region 12 as shown in FIG. 7. When a great deal of data is moved at a time, a processing time at this moment is increased, and a busy time for the host PC becomes too long. Therefore, this data movement is effected in accordance with each part of data per data write processing.

Subsequently, the conversion table for conversion from a logical block address to a physical block address in the regular data region 12 is updated (a step S15). Then, the control advances to (2) and shifts to the step S2 to execute processing at the step S2 and the subsequent steps.

On the other hand, when the current write operation is not the write operation to a logical address within a “(logical address at the end of the write operation)+256 KB” at the step S11, the “write destination flag” is set to the write-once buffer region 13 (a step S12). Then, the control advances to (1) and returns to the step S4 to execute the processing in the “write-once buffer write mode” at the step S4 and the subsequent steps.

That is, when data writing to a logical address which is not within a “(logical address at the end of a previous write operation)+256 KB” is received in the “regular write mode”, the control shifts to the “write-once buffer write mode” on the assumption that the random write continues thereafter (the steps S11 and S12).

Moreover, at the step S5, when the write-once buffer region 13 has no free space in the “write-once buffer write mode”, the control advances to (4) and shifts to the step S13. That is, when the write-once buffer region 13 has no free space, data is directly written into the regular data region 12 irrespective of the write destination mode (the step S5→S13). The above has described the detail of the write operation in the first embodiment.

As explained above, the “regular write mode” and the “write-once buffer write mode” in the first embodiment have the different management methods. In the “regular write mode”, the first conversion from a logical address to a physical address is performed, and data is written into a region specified by the physical address converted based on the first conversion. In the “write-once buffer write mode”, the second conversion from a logical address to a physical address is performed, and data is written into a region specified by the physical address converted based on the second conversion. The second conversion is different from the first conversion. The above-described processing enables performing the random write at a high speed while the write-once buffer region 13 has a free space. When the random write alone continues, the random write performance is lowered after the write-once buffer region 13 is filled with data. However, even when the Readyboost function is used in Windows Vista, the random write using write data of 512 KB does not constantly continue, and the sequential writing having a predetermined length or more is also included. Therefore, the write-once buffer region 13 can be cleared while the sequential writing is executed. That is, data can be moved from the write-once buffer region 13 to the regular data region 12 while the sequential writing is performed, thereby increasing a free space in the write-once buffer region 13. As a result, the definite random write performance can be maintained.

### Second Embodiment

A USB flash memory according to a second embodiment of the present invention will now be described. The second embodiment is different from the first embodiment in a write operation (an algorithm). A hardware configuration is the same as that of the first embodiment depicted in FIG. 1.

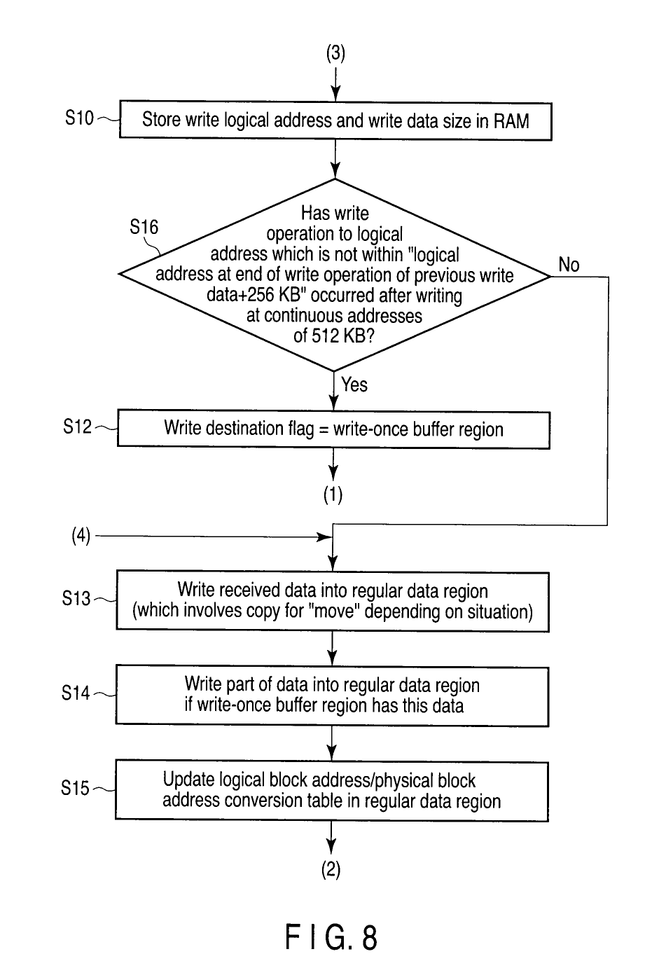

FIGS. 2, 3, and 8 are flowcharts showing a data write operation in a USB flash memory according to the second embodiment. In this embodiment, at a step S16, a condition that “after start of a write operation in units of 512 KB” is added as a condition to shift to a “write-once buffer write mode” at a step S12. Others are the same as those in the first embodiment.

In more detail, when a “write destination flag” is not set to a write-once buffer region 13 at a step S3, the control advances to a step S10. At the step S10, a write logical address and a write data size of write data are stored in an RAM 23 (the step S10). Subsequently, an MPU 21 judges whether data is written to a logical address which is not within a “(logical address at the end of the write operation of previous write data)+256 KB” after data is written at continuous addresses in a unit of 512 KB (a step S16).

When the condition of the step S16 is met and data is written to a logical address which is not within a “(logical address at the end of the write operation of previous write data)+256 KB” after data is written at continuous addresses in a unit of 512 KB, the “write destination flag” is set to the write-once buffer region 13 (a step S12). Then, the control advances to (1) and shifts to a step S4 to execute processing at the step S4 and subsequent steps.

On the other hand, when the condition of the step S16 is not met, write data received from a host PC is written into a regular data region 12 (which involves “copy for move” of data depending on a situation) (a step S13). Thereafter, the control advances to a step S14 to execute processing at the step S14 and subsequent steps.

In this second embodiment, since the write operation with respect to the write-once buffer region 13 is restricted to the write operation in units of 512 KB required by the Readyboost, the write-once buffer region 13 can be more efficiently utilized for the Readyboost as compared with the first embodiment (whereas an effect for the random write in units other than 512 KB is lowered).

It is to be noted that the following processing is also effective in order to avoid a reduction in the random write performance by more efficiently executing clearing processing with respect to the write-once buffer region 13 (data is moved from the write-once buffer region 13 to the regular data region 12 to increase a free space in the write-once buffer region 13).

During initialization processing at the time of turning on a power supply of the USB flash memory, all or part of data stored in the write-once buffer region 13 is moved to the regular data region 12. Further, during an idle period that a host PC does not access the USB flash memory, data stored in the write-once buffer region 13 is moved to the regular data region 12.

It is to be noted that the example that address conversion from a logical address into a physical address is performed in units of physical block in the regular data region has been described in the foregoing embodiment, but the present invention can be likewise applied to a case where logical/physical address conversion is executed in units of ½ or ⅓ of a physical block or in units of twofold of the physical block.

According to the embodiments of the present invention, it is possible to provide the semiconductor memory device which can obtain the random write performance required by the technology “Readyboost” that improves the performance.

Furthermore, the respective foregoing embodiments can be not only solely carried out but also these embodiments can be appropriately combined to be carried out. Moreover, each of the foregoing embodiments includes inventions on various stages, and appropriately combining a plurality of constituent requirements disclosed in each of the foregoing embodiments enables extracting the inventions on the various stages.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor memory device which includes a plurality of blocks each having a plurality of memory cells and in which data is erased in a unit of the block, the device comprising:
a first storage region which has a plurality of blocks and in which first conversion from a logical address to a physical address is performed and data is written into a region specified by the physical address converted based on the first conversion;
a second storage region which has a plurality of blocks and in which second conversion from a logical address to a physical address, the second conversion being different from the first conversion, is performed and data is written into a region specified by the physical address converted based on the second conversion; and
a controller which controls writing data into the first storage region and the second storage region,
wherein the controller shifts to a first write mode that data is written into the first storage region when the controller detects sequential writing of data having a predetermined length or more, and
the controller shifts to a second write mode that data is written into the second storage region when the controller detects that a difference between a logical address at the end of a previous write operation and a logical address at the start of a subsequent write operation is not present in a predetermined range.

2. The device according to claim 1, further comprising a third storage region in which a logical/physical conversion table that is used to perform the second conversion from the logical address to the physical address is stored.

3. The device according to claim 2,
wherein in the second write mode, the controller writes write data into the second storage region, and writes a logical address and a data size of the write data into the third storage region.

4. The device according to claim 1,
wherein the controller has a memory circuit which stores a flag, and determines which one of the first write mode and the second write mode is set by judging a state of the flag.

5. The device according to claim 1,
wherein the controller has a memory circuit,
the controller stores a logical address and a data size of write data in the memory circuit before writing the write data into the second storage region in the second write mode,
the controller judges whether the second storage region has a free space, and
the controller writes the write data into the second storage region when there is the free space or the controller writes the write data into the first storage region when there is no free space.

6. The device according to claim 1,
wherein the controller performs data movement from the second storage region to the first storage region concurrently with writing in the first write mode.

7. The device according to claim 1,
wherein the controller performs data movement from the second storage region to the first storage region at the time of initialization processing.

8. The device according to claim 1,
wherein the controller performs data movement from the second storage region to the first storage region during a period that no access is made to the controller from the outside.

9. A semiconductor memory device which includes a plurality of blocks each having a plurality of memory cells and in which data is erased in a unit of the block, the device comprising:
a first storage region which has a plurality of blocks and in which first conversion from a logical address to a physical address is performed and data is written into a region specified by the physical address converted based on the first conversion;
a second storage region which has a plurality of blocks and in which second conversion from a logical address to a physical address, the second conversion being different from the first conversion, is performed and data is written into a region specified by the physical address converted based on the second conversion; and
a controller which controls writing data into the first storage region and the second storage region,
wherein the controller shifts to one of a first write mode that data is written into the first storage region and a second write mode that data is written into the second storage region depending on whether writing data at random addresses in units of a predetermined storage capacity is detected.

10. The device according to claim 9, further comprising a third storage region in which a logical/physical conversion table that is used to perform the second conversion from the logical address to the physical address is stored.

11. The device according to claim 10,
wherein in the second write mode, the controller writes write data into the second storage region, and writes a logical address and a data size of the write data into the third storage region.

12. The device according to claim 9,
wherein the controller has a memory circuit which stores a flag, and determines which one of the first write mode and the second write mode is set by judging a state of the flag.

13. The device according to claim 9,
wherein the controller has a memory circuit,
the controller stores a logical address and a data size of write data in the memory circuit before writing the write data into the second storage region in the second write mode,
the controller judges whether the second storage region has a free space, and
the controller writes the write data into the second storage region when there is the free space or the controller writes the write data into the first storage region when there is no free space.

14. The device according to claim 9,
wherein the controller performs data movement from the second storage region to the first storage region concurrently with writing in the first write mode.

15. The device according to claim 9,
wherein the controller performs data movement from the second storage region to the first storage region at the time of initialization processing.

16. The device according to claim 9,
wherein the controller performs data movement from the second storage region to the first storage region during a period that no access is made to the controller from the outside.
